(19) United States
(12) Patent Application Publication
(10) Pub. No.: US 2014/0318026 A1
(43) Pub. Date: Oct. 30, 2014

(54) COMPOSITIONS, KITS, SYSTEMS AND METHODS FOR SHARPENING CUTTING BLADES

(71) Applicant: Clipp-Aid LLC, Evanston, IL (US)

(72) Inventors: Romeo Turner, Villa Rica, GA (US); Wubendanchi T. Mitchell, Evanston, IL (US); Adrian V. Mitchell, Evanston, IL (US)

(21) Appl. No.: 14/324,481

(22) Filed: Jul. 7, 2014

Related U.S. Application Data
(63) Continuation-in-part of application No. 13/906,422, filed on May 31, 2013.
Application No. 13/906,422 is a continuation-in-part of application No. 13/438,913, filed on Apr. 4, 2012, now Pat. No. 8,808,060.
(60) Provisional application No. 61/474,374, filed on Apr. 12, 2011.

(51) Int. Cl. B24D 15/06; C09K 3/14

(52) U.S. Cl. CPC B24D 15/063; C09K 3/1436
USPC 51/307

(57) ABSTRACT

A kit for use in sharpening blades of a hair cutting device includes a packet defining an interior area that is sealingly enclosed within the packet and a pre-determined amount of a sharpening composition disposed within the interior area of the packet. The sharpening composition includes a plurality of crystalline particles having exterior surfaces dyed a color different from the natural color of the crystals. The amount of sharpening composition, average initial diameter of the crystalline particles, and hardness of the crystalline particles are such that the sharpening composition facilitates sharpening of a hair cutting device. Compositions for use in sharpening blades of a hair cutting device are also disclosed.

### CROSS-REFERENCE TO RELATED APPLICATIONS

This application is a continuation-in-part application of U.S. patent application Ser. No. 13/906,422, filed on May 31, 2013, which is a continuation-in-part application of U.S. patent application Ser. No. 13/438,913, filed on Apr. 4, 2012, which claims the benefit of, and priority to, U.S. Provisional Patent Application No. 61/474,374, filed on Apr. 12, 2011, the entire contents of each of which are hereby incorporated by reference herein.

### BACKGROUND

1. Technical Field

The present disclosure relates to electric hair cutting devices and, more particularly, to systems and methods for sharpening the cutting blades of electric hair clippers, trimmers, and other hair cutting devices.

2. Background of Related Art

An electric hair clipper typically includes a housing configured to be grasped by a user and a pair of blades layered on top of one another at one end of the housing. Typically, one of the blades, e.g., the stationary blade, is fixed relative to the housing, while the other blade, e.g., the movable blade, is movable relative to the stationary blade and the housing. Each of the blades includes a plurality of spaced-apart teeth. A motor (or other suitable mechanism) disposed within the housing is coupled to the movable blade to oscillate the movable blade relative to the stationary blade between an aligned position, wherein the teeth of the blades are aligned with one another, and an offset position, wherein the teeth of the blades are offset relative to one another. The stationary blade is typically disposed exteriorly of the movable blade to shield the movable blade.

In use, when the blades are disposed in the aligned position, hair is permitted to enter the spaces between the aligned teeth. When the blades are subsequently moved to the offset position, the hair disposed between the teeth is cut in a scissor-like fashion. That is, oscillation of the movable blade between the aligned and offset positions allows hair to be repeatedly moved into position between the teeth and subsequently cut.

Other electric hair cutting devices, e.g., electric hair trimmers, include similar components and function similarly to electric hair clippers.

As can be appreciated, if the cutting teeth of one or both of the blades become dull, cutting efficiency may be reduced and the likelihood of hair becoming trapped between the teeth, rather than being cut by the teeth, is increased. Therefore, it is important to periodically sharpen the cutting teeth of the blades to maintain adequate sharpness of the cutting teeth.

### SUMMARY

The features of any of the embodiments described herein, to the extent consistent, may be used in conjunction with the features of any of the other embodiments described herein.

Provided in accordance with the present disclosure are various embodiments of kits for use in sharpening blades of a hair cutting device. The kits include a packet defining an interior area that is sealingly enclosed within the packet, and a pre-determined amount of a sharpening composition disposed within the interior area of the packet. The sharpening composition includes a plurality of crystalline particles having exterior surfaces dyed a color different from the natural color of the crystals. The amount of sharpening composition, average initial diameter of the crystalline particles, and hardness of the crystalline particles are such that the sharpening composition facilitates sharpening of a hair cutting device.

In embodiments, the packet includes a single piece of material bent back on itself to define a lower end of the packet. The single piece of material is sealed along first and second sides of the packet and an upper end of the packet to sealingly enclose the interior area of the packet.

In embodiments, the packet includes a cut-line disposed adjacent the upper end of the packet. The cut-line indicates where to cut-open the packet to provide access to the interior area.

In embodiments, the lower end of the packet defines a concave configuration such that the packet defines a U-shaped configuration.

In embodiments, the single piece of material is sealed along the first and second sides and the upper end via any known methods known in the art including, but not limited to, heat sealing, adhesive, and other suitable sealing methods.

In embodiments, the packet is formed from a plurality of layers including at least one support layer and at least one barrier layer. The at least one support layer may include a foil layer. The at least one barrier layer may provide at least one of a moisture barrier, a microbial barrier, or an oxygen barrier.

In embodiments, the pre-determined amount of sharpening composition may be from about 0.05 ounces to about 1.50 ounces. More specifically, where the kit is configured for use in sharpening trimmer blades of a hair cutting device, the pre-determined amount of sharpening composition may be from about 0.05 ounces to about 0.25 ounces; where the kit is configured for use in sharpening small clipper blades of a hair cutting device, the pre-determined amount of sharpening composition may be from about 0.10 ounces to about 0.50 ounces; where the kit is configured for use in sharpening medium clipper blades of a hair cutting device, the pre-determined amount of sharpening composition may be from about 0.30 ounces to about 1.00 ounces; and where the kit is configured for use in sharpening large clipper blades of a hair cutting device, the pre-determined amount of sharpening composition may be from about 0.40 ounces to about 1.50 ounces.

In embodiments, the hardness of the plurality of crystalline particles may be from about 2.6 to about 4.5 according to the Mohs hardness scale.

In embodiments, the sharpening composition includes a main crystalline substance having a hardness below about 2.6 according to the Mohs hardness scale, and a hardening agent that increases the hardness of the main crystalline substance such that the hardness of the plurality of crystalline particles may be from about 2.6 to about 4.5 according to the Mohs hardness scale. In embodiments, the main crystalline substance may be sodium chloride. In embodiments, the hardening agent may be potassium iodide, calcium silicate, or any other hardening agents or compounds.

In embodiments, the main crystalline substance comprises from about 70% to about 99% by weight of the sharpening composition. The hardening agent may comprise from about 0.05% to about 10% by weight of the sharpening composition. The sharpening composition may further include at least one anti-coalescing agent that comprises from about 0.05% to about 10% by weight of the sharpening composition. The exterior surfaces of the crystalline particles may be dyed with at least one dying agent that comprises from about 0.05% to about 10% by weight of the sharpening composition. The sharpening composition may additionally or alternatively include at least one preservative that comprises from about 0.05% to about 10% by weight of the sharpening composition.

In embodiments, the average initial diameter of the crystalline particles is from about 0.15 mm to about 0.90 mm. In embodiments, the shape of the crystalline particles may be symmetrical such as but not limited to, a cubic shape, a circular shape, or a pyramidal shape, or may be asymmetrical, amorphous, or irregular. In other embodiments, the shape of the crystalline particles may be amorphous or indefinite. Any shape known in the art of particles may be utilized such that the sharpening composition is configured to fit in between the teeth of the trimmer and clipper blades thereby facilitating sharpening of a hair cutting device.

### BRIEF DESCRIPTION OF THE DRAWINGS

Various aspects of the present disclosure are described herein with reference to the drawings wherein like reference numerals identify similar or identical elements:

FIG. 1 illustrates a blade sharpening system, or kit, provided in accordance with the present disclosure and shown including a receptacle configured to retain a sharpening composition therein, a dispensing spoon, and a pouch;

FIG. 2 is a perspective view of an exemplary electric hair clipper configured for use with the sharpening systems and methods of the present disclosure;

FIG. 3 is a top, exploded view of the electric hair clipper of FIG. 2 wherein a portion of the housing has been removed to show the internal components thereof;

FIG. 4A is a front view of the movable and stationary blades of the electric hair clipper of FIG. 2 shown disposed in the aligned position;

FIG. 4B is a front view of the movable and stationary blades of the electric hair clipper of FIG. 2 shown disposed in the offset position;

FIG. 5A is a side view of the pouch of FIG. 1 including the sharpening composition disposed therein in crystalline form;

FIG. 5B is a side view of the pouch of FIG. 1 including the head of the electric hair clipper of FIG. 2 submerged within the sharpening composition in crystalline form;

FIG. 5C is a side view of the pouch of FIG. 1 including the sharpening compound disposed therein in powder form;

FIG. 6 is a flow diagram of a blade sharpening method provided in accordance with the present disclosure;

FIG. 7A is a top view of an unassembled packet provided in accordance with the present disclosure;

FIG. 7B is an exploded, perspective view illustrating the layers of material forming the packet of FIG. 7A; and

FIG. 7C is a transverse, cross-sectional view of the packet of FIG. 7A assembled, including a sharpening composition therein, wherein the packet is disposed in an open state.

### DETAILED DESCRIPTION

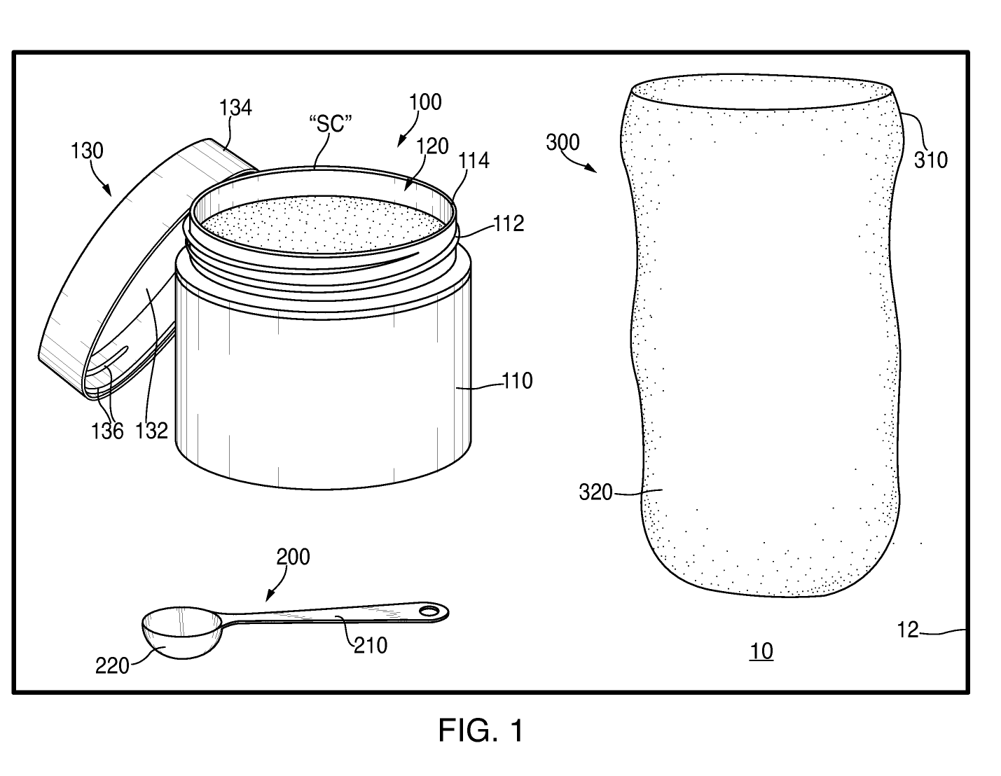

Turning now to FIG. 1, an illustrative embodiment of a blade sharpening system provided in accordance with the present disclosure is shown generally identified by reference numeral 10. Blade sharpening system 10 may be provided as a blade sharpening kit 12, although the components of blade sharpening kit 12 may alternatively be provided separately. Blade sharpening system 10 generally includes a receptacle 100 configured to retain a sharpening composition “SC” therein, a dispensing spoon 200, and a pouch 300.

Receptacle 100 is shown generally including a base 110 having a hollow interior 120 and a lid 130 releasably engagable with base 110. Base 110 may be formed from a plastic or any other suitable material. Base 110 is configured to retain the sharpening composition “SC” therein and includes annular external threading 112 disposed towards the open end 114 thereon. Lid 130 includes a top portion 132 and an annular portion 134 that includes annular internal threading 136 configured complementarily to threading 112 of base 110 to permit releasable engagement of lid 130 about the open end of base 110 to inhibit the sharpening composition “SC” from spilling out of base 110, chemically reacting with other substances, and/or being contaminated by other substances. Other releasable engagement mechanisms, e.g., snap-fit, friction fit, etc., may also be provided.

With continued reference to FIG. 1, dispensing spoon 200 generally includes a handle portion 210 and a scoop portion 220. Dispensing spoon 200 is configured to facilitate the transfer of the sharpening composition “SC” from receptacle 100 to pouch 300 in measured increments. For example, dispensing spoon 200 may be configured to define a capacity of about ⅛ teaspoon, although other size dispensing spoons are also contemplated.

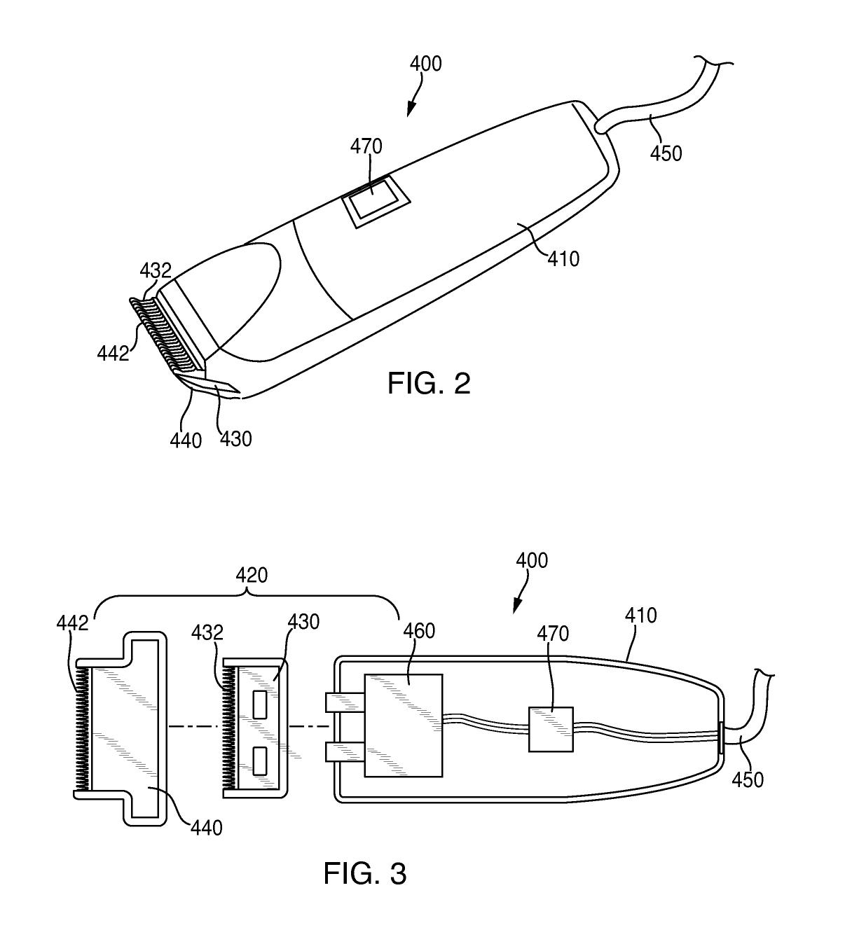

Pouch 300 is formed from any suitable tear-resistant, transparent or partially transparent, and impermeable material for retaining the sharpening composition “SC” therein. The pouch 300 has sufficient transparency so as to permit the user to visualize the sharpening composition “SC” from the exterior of pouch 300. Alternatively, pouch 300 may be formed from a translucent or opaque material. Pouch 300 defines an open end 310 that is configured to permit the sharpening composition “SC” to be deposited into the interior of pouch 300. Pouch 300 is configured to permit insertion of the working end of an electric hair clipper 400 (FIG. 2), electric hair trimmer (not shown), or other similar device therein, as will be described in greater detail below.

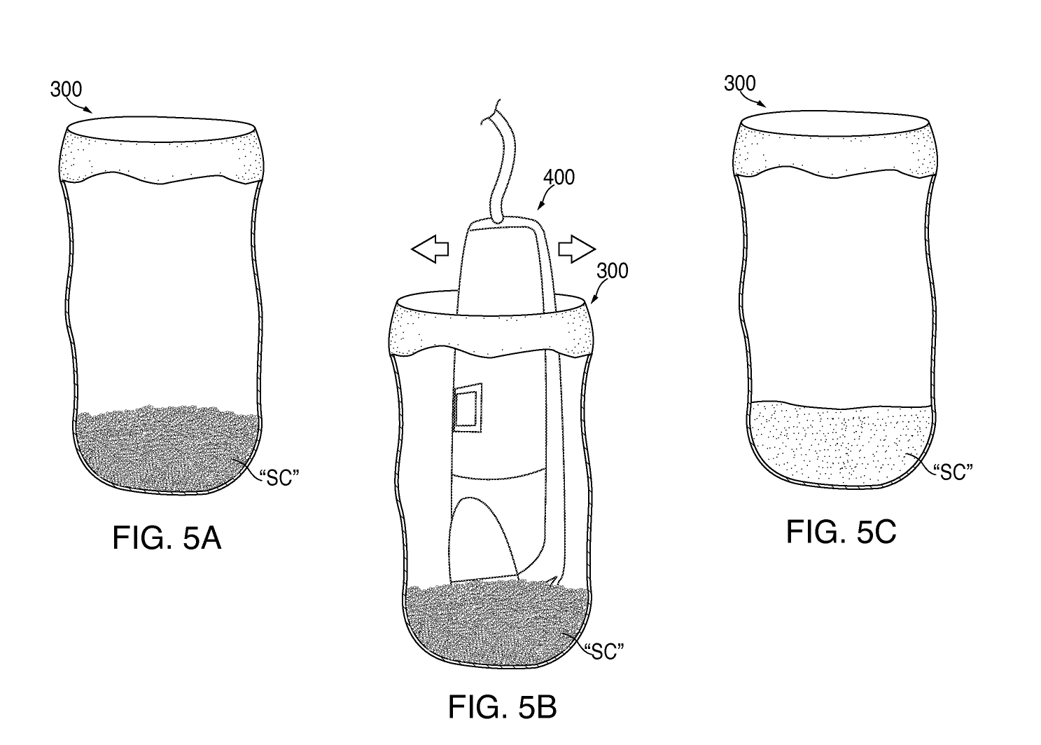

Continuing with reference to FIG. 1, the sharpening composition “SC,” as will be described in greater detail below, is initially provided in crystalline form. The sharpening composition “SC” may primarily include an abrasive substance such as sodium chloride, although other suitable abrasive substances or combinations of substances may also be provided. Further, the exteriors of the crystals (e.g., the exposed surface area of the crystals) of the sharpening composition “SC,” including e.g., the sodium chloride crystals, may be dyed with any suitable dye, both natural and/or synthetic dyes, e.g., food coloring, and/or pigments to provide better contrast relative to the natural color or shade of the sharpening composition “SC” to facilitate visualization of the state of the sharpening composition “SC.” That is, dyeing the sharpening composition “SC” facilitates the visual determination of whether the sharpening composition “SC” is in a crystalline state (FIGS. 5A-5B) or a powder state (FIG. 5C), the importance of which will become more apparent hereinbelow. For example, the exteriors of the crystals of the sharpening composition “SC” may be dyed a relatively dark color or shade as compared to the interior thereof, although other configurations are also contemplated.

In embodiments, the sharpening composition “SC” is formulated to define a hardness, according to the Mohs scale of mineral hardness, that is within the range of about 2.6 to about 4.5. A hardness within this range is desirable as it has been found that sodium chloride alone (having a Mohs hardness of 2.5) is not sufficiently hard to facilitate sharpening in a timely manner, while sand and other compositions having a Mohs hardness above 4.5 are too hard and likely to damage the blades being sharpened. The sharpening composition “SC” may be formulated using the ingredients disclosed below in appropriate proportion in order to achieve a hardness within the above-noted range as well as the other properties of the sharpening composition “SC” disclosed below.

In embodiments, the sharpening composition “SC” may include a main crystalline substance comprising from about 70% to about 99% by weight of the sharpening composition “SC” one or more hardening agents, one or more anti-coalescing agents, one or more dying agents, and/or one or more preservatives that together comprise from about 4% to about 30% by weight of the sharpening composition “SC.”

In embodiments, the main crystalline substance may be, for example, sodium chloride, although other similar abrasives with similar mineral hardness may be utilized. In embodiments, the sharpening composition “SC” may include sodium chloride in amounts of from about 70% and about 99% by weight of the sharpening composition “SC,” in other embodiments, of from about 85% to about 98% by weight of the sharpening composition “SC.” In still further embodiments, of from about 94% to about 96% by weight of the sharpening composition “SC.”

In embodiments, the one or more hardening agents may be provided to increase the hardness of the main crystalline substance (where needed to achieve a hardness within the above-identified range, such as in the case of sodium chloride). In embodiments, the one or more hardening agents may be selected from potassium iodide, sodium iodide, sodium thiosulphate, the like, and combinations thereof. In embodiments, the sharpening composition may include potassium iodide in amounts of from about 0.05% to about 10% by weight of the sharpening composition “SC,” in other embodiments from about 0.08% to about 3.0% by weight of the sharpening composition “SC.”

The sharpening composition “SC” of the present disclosure may also include one or more anti-coalescing agent or additive to prevent the formation of lumps in the sharpening composition and for ease in packaging, storage and transport. They function either by absorbing excess moisture, or by coating the plurality of crystals and making them water and/or oil repellent. Suitable anti-coalescing agents may include calcium silicate, sodium silicate, sodium aluminosilicate, calcium aluminosilicate, aluminium silicate, potassium aluminium silicate, magnesium trisilicate, sodium ferrocyanide, potassium ferrocyanide, calcium ferrocyanide, calcium carbonate, magnesium carbonate, tricalcium phosphate, powdered cellulose, sodium bicarbonate, bone phosphate, silicon dioxide, talcum powder, bentonite, stearic acid, polydimethylsiloxane, dextrose, and combinations thereof.

In embodiments, the anti-coalescing agent may include calcium silicate. In other embodiments, the anti-coalescing agent may include sodium bicarbonate. In embodiments, the anti-coalescing agent may be a finely divided product having an average ultimate particle size below about 0.1 microns, and having a surface area ranging from about 10 to about 150 square meters per gram. In embodiments, the anti-coalescing agent may be incorporated in the sharpening composition simply by mixing commercial abrasive such as for example, crystalline sodium chloride, which may or may not contain impurities, with the finely divided the anti-coalescing agent. In embodiments, the anti-coalescing agent may comprise from about 0.05% to about 10% by weight of the sharpening composition “SC,” in other embodiments, from about 0.08% to about 3.0% by weight of the sharpening composition “SC.”

In embodiments, the sharpening composition “SC” may include at least one dying agent. In embodiments, the at least one dying agent may include FD and C Red No. 40; C.I. Acid Yellow 23; C.I. Acid Blue 9, disodium salt, and/or other suitable dying agents that together or individually comprise from about 0.05% to about 30% by weight of the sharpening composition “SC” and are capable of dying the sharpening composition “SC” a color different from its natural color. In embodiments, the at least one dying agent may comprise from about 0.08% to about 30%.

In embodiments, the sharpening composition “SC” of the present disclosure may also include at least one preservative. Suitable preservatives may include, for example, propylparaben, methylparaben, ethylparaben, butylparaben, sodium benzoate, potassium sorbate, propylene glycol, combinations thereof, and any other suitable preservatives known in the art. In embodiments, the preservative may include propylparaben or propyl 4-hydroxybenzoate. In other embodiments, the preservative may include propylene glycol. The preservative may be present in the sharpening composition “SC” in amounts of from about 0.05% to about 10% by weight. In embodiments, the preservative may be present in amounts of from about 0.05% to about 10% by weight.

The sharpening composition “SC,” in embodiments, defines an average initial crystal size within the range of about 0.15 mm to about 0.90 mm. A size in this range is sufficiently large to provide enough surface area to enable pulverization of the crystals by the blades to sharpen the blades in a timely manner, and sufficiently small to permit the crystals to readily move between the teeth of the blades to enable sharpening. In embodiments, the shape of the crystalline particles may be symmetrical such as but not limited to, a cubic shape, a circular shape, pyramidal shape, or other non-symmetrical, amorphous, or irregular shape. In other embodiments, the shape of the crystalline particles may be amorphous or indefinite. Any shape known in the art of particles may be utilized such that the sharpening composition is configured to fit in between the teeth of the trimmer and clipper blades thereby facilitating sharpening of a hair cutting device.

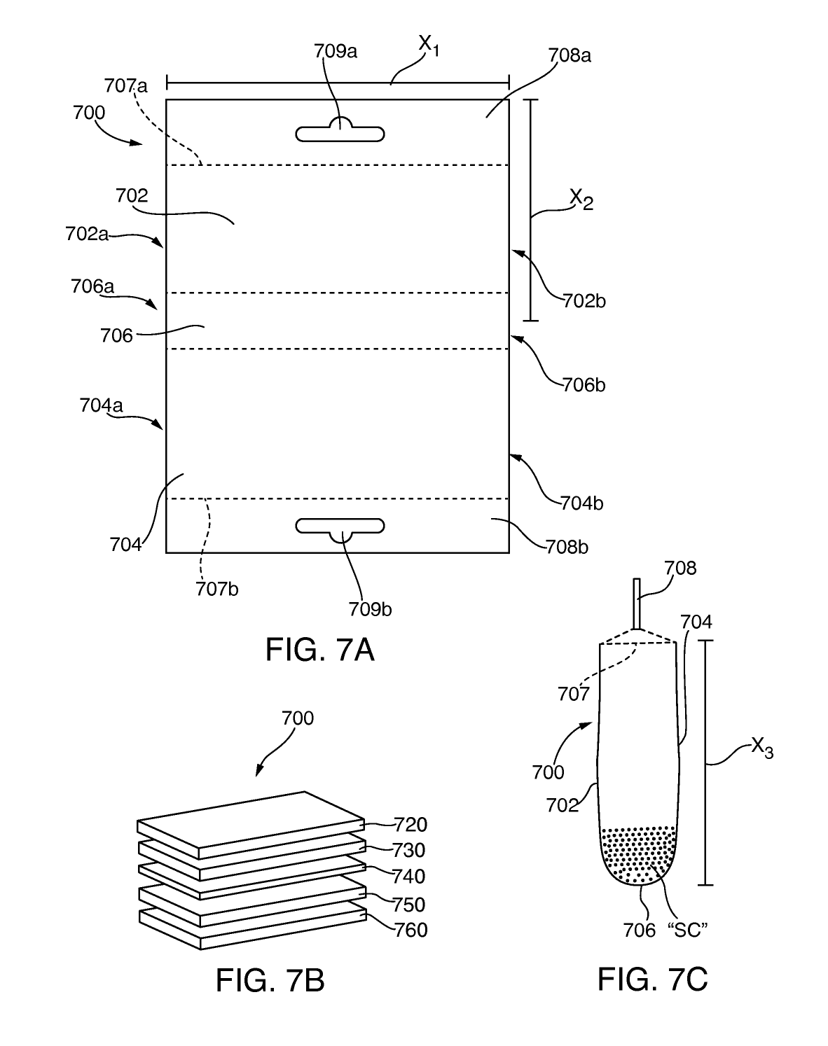

The particular average initial crystal size may ultimately depend upon the size and/or type of the blades to be sharpened, the hardness of the sharpening composition “SC,” and the amount of sharpening composition “SC” provided and, likewise, the particular hardness of the sharpening composition “SC” and the amount of sharpening composition “SC” may be selected based upon one another, the size and/or type of the blades to be sharpened, and/or the average initial crystal size. In other words, it has been found that the average initial crystal size, hardness of the crystals, and amount of crystals are the three main factors that enable efficient and effective blade sharpening for any particular blades. Suitable average initial crystal size and hardness ranges are detailed above, while the amount of sharpening composition “SC” suitable for sharpening a particular type and/or size of blades will be detailed below with respect to FIGS. 7A-7C.

Turning to FIGS. 2 and 3, an electric hair clipper provided in accordance with the present disclosure and configured for use with blade sharpening system 10 (FIG. 1) is shown generally designated by reference numeral 400. Although only one embodiment of an electric hair clipper 400 is shown, it is contemplated that the systems and methods of the present disclosure are equally applicable for use with any powered hair cutting device, e.g., clippers, trimmers, etc. having one or more moving blades that require sharpening.

Clipper 400 generally includes a handle portion or housing 410 configured to be grasped by a user, a working end 420 which supports movable and stationary blades 430, 440, respectively, and a cord 450 for connecting clipper 400 to a source of energy (although clipper 400 may alternatively be configured as a battery-powered device). Movable blade 430 is disposed at working end 420 of clipper 400 and is operably coupled to a motor 460 disposed within housing 410. Motor 460, in turn, is electrically coupled to the source of energy (not shown), e.g., via cord 450, to power motor 460. An actuator 470 disposed on housing 20 is coupled to motor 460 for selectively activating (and deactivating) motor 460, e.g., turning the clipper 400 ON and OFF. Stationary blade 440 is disposed at working end 420 of clipper 400 exteriorly of movable blade 430 and is fixed relative to housing 410.

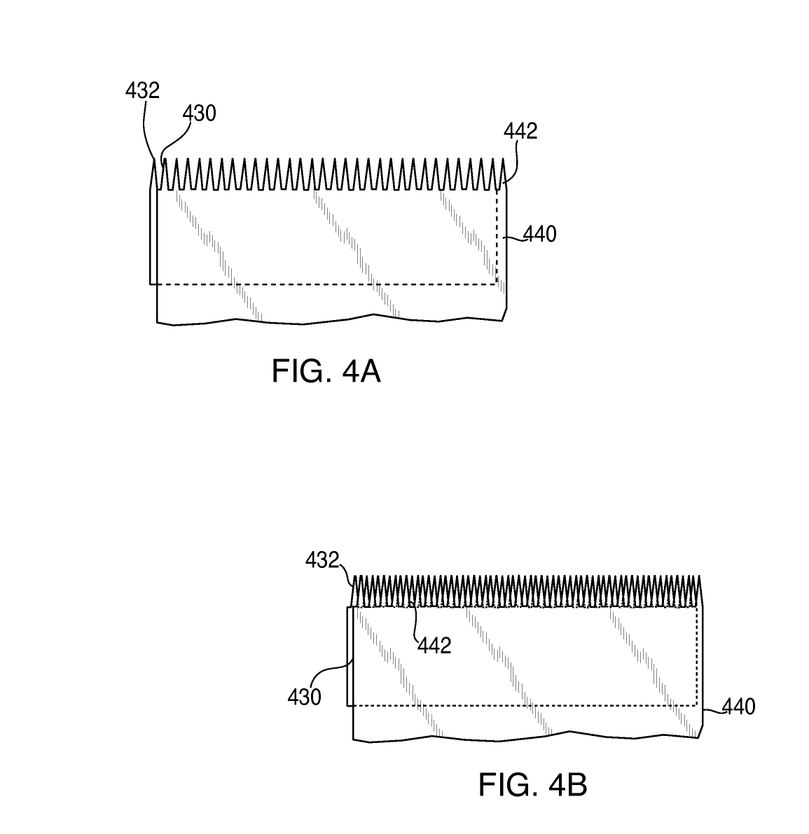

As best shown in FIGS. 3, 4A, and 4B, movable and stationary blades 430, 440, respectively, each include a plurality of spaced-apart teeth 432, 442, respectively. As mentioned above, stationary blade 440 is fixed relative to housing 410. Movable blade 430 is coupled to motor 460 for oscillating movable blade 430, e.g., translating movable blade 430 in side-to-side motion, relative to stationary blade 440 between an aligned position (FIG. 4A), wherein teeth 432, 442, of blades 430, 440, respectively, are substantially aligned with one another, and an offset position (FIG. 4B), wherein teeth 432, 442, of blades 430, 440, respectively, are offset relative to one another.

The lateral sides of the teeth 432, 442 of either or both of the movable and stationary blades 430, 440, respectively, define sharpened cutting edges configured to facilitate the cutting of hair disposed between teeth 432, 442 of blades 430, 440, respectively. More specifically, in use, e.g., once actuator 470 is activated to turn clipper 400 ON, motor 460 operates to oscillate movable blade 430 between the aligned position (FIG. 4A), wherein hair is permitted to enter the spaces between the aligned teeth 432, 442, and the offset position (FIG. 4B), wherein the hair disposed between teeth 432, 442 is cut in a sheering, or scissor-like fashion by the sharpened cutting edges of blade(s) 430, 440. As can be appreciated, if the sharpened cutting edges of blade(s) 430, 440 become dull, cutting efficiency is reduced.

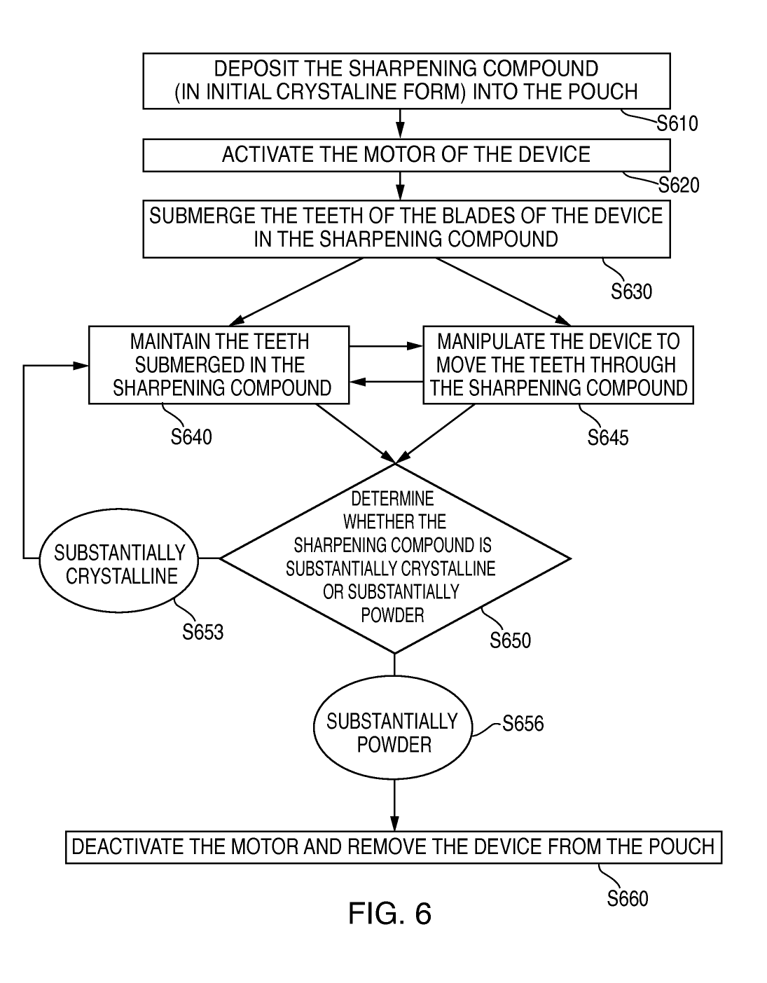

Referring now to FIGS. 5A, 5B, and 6, in conjunction with FIGS. 1, 2, 3, 4A, and 4B, the use and operation of blade sharpening system 10, e.g., for sharpening blades 430, 440 of clipper 400, is described. Although described with respect to clipper 400, blade sharpening system 10 and the methods of sharpening cutting blades described herein may alternatively be used for sharpening the blades of any suitable powered hair cutting device, e.g., clippers, trimmers, etc. In preparation for sharpening, blades 430, 440 of clipper 400 are cleaned in accordance with the manufacturer's instructions or accepted industry standards. For example, sharpening blades 430, 440 of clipper 400 may be cleaned by brushing off any excess debris from the blades and then submerging the blades in an antibacterial cleaning solution. Once blades 430, 440 of clipper 400 are cleaned, blades 430, 440 are ready for sharpening. However, removing debris is not essential as the sharpening detailed below will still be affected even if the debris are not first removed.

Initially, as indicated in step S610, an appropriate amount of sharpening composition “SC,” in its initial crystalline form, is deposited into pouch 300, e.g., an amount dependent on the size of the blades to be sharpened. More particularly, the user removes lid 130 of receptacle 100 and, using dispensing spoon 200, scoops the appropriate amount of crystalline sharpening composition “SC” out of receptacle 100, and deposits the sharpening composition “SC” into pouch 300. An appropriate amount of sharpening composition is that which is sufficient to immerse the teeth 432, 442 of blades 430, 440. For example, it has been found that ¼ teaspoon is a sufficient amount of sharpening composition “SC” for sharpening clipper blades, e.g., blades 430, 440 of clipper 400, while ⅛ teaspoon is sufficient for sharpening trimmer blades (not shown). However, other amounts are also contemplated. As mentioned above, configuring dispensing spoon 200 to define a capacity of ⅛ teaspoon (or other suitable incremental capacity) allows the user to quickly and easily deposit the appropriate amount of sharpening composition “SC” into pouch 300, e.g., one scoop (for clippers) or two scoops (for trimmers).

As indicated in step S620, motor 460 of clipper 400 is activated, e.g., via depressing actuator 470, to turn clipper 400 ON, e.g., to oscillate movable blade 430 relative to stationary blade 440. Once the sharpening composition “SC” has been deposited into pouch 300 and with clipper 400 in the ON state, working end 420 of clipper 400 is inserted into pouch 300 such that movable and stationary blades 430, 440 of clipper 400 are at least partially submerged in the sharpening composition “SC,” as indicated in step S630. More specifically, blades 430, 440 are submerged in the sharpening composition “SC” sufficiently such that teeth 432, 442 of blades 430, 440, respectively, are submerged in the sharpening composition “SC.” Alternatively, working end 420 of clipper 400 may be submerged in the sharpening composition “SC” prior to activating motor 460.

Next, as indicated in steps S640 and S645, teeth 432, 442 of blades 430, 440, respectively, are maintained in position (submerged in the sharpening composition “SC”) or clipper 400 is manipulated, e.g., in a side-to-side and/or back and forth motion relative to pouch 300, to move teeth 432, 442 through the sharpening composition “SC” (while also maintaining teeth 432, 442 of blades 430, 440 submerged in the sharpening composition “SC”). Manipulating clipper 400 such that teeth 432, 442 are moved through sharpening composition “SC” facilitates the sharpening process. More specifically, it has been found that, for a typical hair cutting device, e.g., clipper 400, blades 430, 440 will be sufficiently sharpened between about less than 1 minute and to about 3 minutes, in other embodiments between about 1 minute to about 2 minutes if clipper 400 is continuously manipulated within the sharpening composition “SC.” In embodiments, if the clipper 400, blades 430, 440 are not sufficiently sharpened in the disclosed sharpening times, sharpening may be repeated as necessary until desired sharpness is achieved. On the other hand, sufficient sharpening may require up to about 15 minutes where clipper 400 remains generally stationary relative to pouch 300 and sharpening composition “SC” during the sharpening process. The above-noted sharpening times are provided for exemplary and comparative purposes only. The presently disclosed sharpening systems and methods, as will be described below, allow the user to visually verify when sharpening is complete, rather than relying on a pre-determined sharpening time.

As can be appreciated, depending on the configuration and state of the cutting blades, the particular device used, the degree of manipulation (or lack thereof) of the device within pouch 300, and other factors, sharpening times may vary. Accordingly, relying on a pre-determined sharpening time may prove insufficient, e.g., may result in under-sharpening or over-sharpening.

In order to determine whether sharpening is complete in accordance with the systems and methods of the present disclosure, as indicated in step S650, the user views the sharpening composition “SC” through pouch 300 to determine whether the sharpening composition “SC” is in substantially crystalline form (its original form) or has been transformed to a substantially powder form. During sharpening, the crystals of the sharpening composition “SC” are moved between teeth 432, 442 of blades 430, 440 when teeth 432, 442 are disposed in the aligned position and are subsequently cut or broken by sheering teeth 432, 442 as the teeth 432, 442 are moved to the offset position. This process sharpens the lateral cutting edges of the teeth 432, 442 of blades 430, 440, respectively. As the crystals are cut or broken and as the cut or broken crystal fragments are cut or broken further, sharpening composition “SC” is converted into powder form. That is, conversion of the sharpening composition “SC” from crystalline form to powder form coincides with the sharpening of blades 430, 440 of clipper 400. Thus, determining whether the sharpening composition “SC” is substantially crystalline (i.e., relatively little sharpening has occurred) or substantially powder (i.e., relatively more sharpening has occurred) indicates whether sharpening is complete or more sharpening is required.

With continued reference to step S650 of FIG. 6, determining whether the sharpening composition “SC” is substantially crystalline or substantially powder is not only accomplished by viewing the sharpening composition “SC” to determine the size of the particles, but may also be accomplished by viewing the color or shade of the sharpening composition “SC.” That is, since the exteriors of the crystals (e.g., the exposed surface area of the crystals) of the sharpening composition “SC” are dyed with a relatively dark color or shade to contrast with the natural lighter color or shade (e.g., the unexposed, internal portions of the crystals) of the sharpening composition “SC,” the overall color or shade of the sharpening composition “SC” lightens as the crystals are cut or broken into smaller pieces and, ultimately, into powder form. This is because, during the cutting or breaking of the crystals, the interior of the crystals, which are un-dyed and, thus, exhibit the natural, lighter color or shade of the sharpening composition “SC” become exposed, thus lightening the overall color or shade of the sharpening composition “SC.” Accordingly, when the sharpening composition “SC” has substantially changed from its initial, darker color or shade of the dyed crystals to the lighter color or shade of the powder, the user is alerted that sharpening is complete by the color or shade change of the sharpening composition “SC.”

As indicated by step S653, if sharpening is not yet complete, e.g., if the sharpening composition “SC” is still substantially crystalline (exhibiting the dyed, darker color or shade), the method reverts back to steps S640 and/or S645, wherein teeth 432, 442 of blades 430, 440 are maintained in position (submerged in the sharpening composition “SC”) and/or clipper 400 is manipulated relative to pouch 300, to move teeth 432, 442 through sharpening composition “SC.”

As indicated by step S656, if sharpening is complete, e.g., if the sharpening composition “SC” is substantially powder (exhibiting the lighter, natural color or shade), the method proceeds to step S660, wherein motor 460 of clipper 400 is deactivated, thus turning clipper 400 OFF. Clipper 400 is then be removed from pouch 300. Finally, blades 430, 440 of clipper 400 are once again cleaned, rendering clipper 400 sharpened, cleaned, oiled, and ready for re-use.

Also provided in accordance with the present disclosure are methods of manufacturing the sharpening composition “SC.” In accordance with such methods, a crystalline composition is initially provided. For simplicity, the crystalline composition is referred to simply as a plurality of “crystals” hereinbelow, which encompasses any suitable form of crystals, crystalline structures, and the like. In particular embodiments, the crystalline composition is iodized sodium chloride, although any other suitable crystalline compositions, such as those detailed above, may alternatively or additionally be provided. The iodized sodium chloride crystals are provided in a natural state, wherein the crystals exhibit a generally white color (although the natural color may include shades of light gray, light pink, and/or other lighter-in-shade color). As can be appreciated, depending on the particular crystalline composition used, the natural crystals may exhibit different colors or shades thereof.

Next, a dying agent (or multiple dying agents) is added to the crystals. The dying agent(s) may include, for example, one or more food colors and/or any other suitable dying agent(s), such as those detailed above. As mentioned above, it is envisioned that the dying agent(s) be selected such that, once coated and dried on the crystals, the dying agent(s) exhibit an exterior color sufficiently distinguishable from the white color (or other suitable color or shade) of the natural crystals, e.g., a relatively dark color. In embodiments where preservatives or anti-coalescing agents are provided, these may be introduced to the natural crystals prior to or after introduction of the dying agent(s).

Once the dying agent(s) is added to the crystals, the crystals are mixed, shifted, or otherwise manipulated to fully and consistently coat the crystals with the dying agent(s) and such that the natural color, e.g., white color, of the crystals is no longer visible. Once this full and consistent coating is achieved, as evidenced by the full covering of the natural color of the crystals with the dying agent(s), the coated crystals may be dried.

In order to dry the coated crystals, the coated crystals are laid on a metallic or otherwise thermally conductive and/or reflective surface. Alternatively, the coated crystals may be laid on any other suitable surface, e.g., a plastic surface. In particular embodiments, the coated crystals are placed on a substantially flat sheet of foil. The coated crystals are laid on the surface to define a depth of between about ¼″ and about ½. It has been found that this depth range facilitates uniform drying of the coated crystals. However, depending on a particular configuration or circumstance(s), other depth ranges are also contemplated. The coated crystals may further be surrounded and/or covered by additional thermally conductive and/or reflective materials, e.g., additional sheets of foil. A light, heat lamp, or other suitable heat source is then exposed to the coated crystals to facilitate drying of the coated crystals. Alternatively, the coated crystals may be dried at room temperature, e.g., without assistance from a heat source. Direct heat from the heat source as well as heating facilitated by reflection off of and/or conduction by the foil(s) helps achieve uniform drying of the coated crystals. To further promote uniform drying of the coated crystals, the coated crystals may be mixed, shifted, or otherwise manipulated periodically during the drying process.

It is envisioned that the heat source and thermally conductive and/or reflective surfaces contribute to achieve a greater than room-temperature environment for drying the coated crystals. Such a feature increases the brittleness of the coated crystals during the drying process, thus providing a more brittle sharpening composition “SC,” which reduces sharpening time. Once the coated crystals are sufficiently dried, as indicated by full and consistent coloring of the crystals (and no visible natural color), the sharpening composition “SC” may be packaged, e.g., in a receptacle 100 (FIG. 1).

Turning now to FIGS. 7A-7C, a packet 700 provided in accordance with the present disclosure is shown. Packet 700, during manufacturing, is loaded with an appropriate amount of sharpening composition “SC” and is thereafter sealed such that, as detailed below, packet 700 provides an all-in-one sharpening “kit.” As will also be detailed below, various packets 700 may be provided, each containing a predetermined amount of sharpening composition “SC,” such that the user need only select the packet 700 containing the appropriate amount of sharpening composition “SC” based upon the type and/or size of the blades to be sharpened.

Referring to FIG. 7A, packet 700 is shown in unassembled form defining a generally rectangular configuration having a first body portion 702, a second body portion 704, a base portion 706 interconnecting the first and second body portions 702, 704, respectively, and first and second top portions 708a, 708b extending from the opposite ends of respective body portions 702, 704. Top portions 708a, 708b may further define cut-outs 709a, 709b configured to align with one another when packet 700 is fully assembled and sealed to permit packet 700 to hang from a standard merchandise hanger (not shown).

During assembly, in embodiments, first and second body portions 702, 704 are brought into close approximation with one another to define a generally U-shaped configuration (see FIG. 7C), e.g., wherein base portion 706 defines a concave configuration facing the interior of the U-shaped packet 700. Thereafter, first side edges 702a, 704a of first and second body portions 702, 704, respectively, are sealed to one another and a segment, e.g., half of, first side edge 706a of base portion 706 is sealed to the remainder, e.g., the other half, of first side edge 706a of base portion 706. In embodiments, the packet may be sealed using any suitable sealing methods known in the art such as for example, heat sealing, adhesive, and combinations thereof. Likewise, second side edges 702b, 704b of first and second body portions 702, 704, respectively, are sealed to one another, e.g., via heat sealing, and a segment, e.g., half of, second side edge 706b of base portion 706 is sealed to the remainder, e.g., the other half, of second side edge 706b of base portion 706.

Next, the interior of the U-shaped packet 700 is filled with a predetermined amount of sharpening composition “SC,” e.g., by introducing the sharpening composition “SC” between first and second top portions 708a, 708b. Thereafter, first and second top portions 708a, 708b are sealed to one another, e.g., via heat sealing, to define top portion 708 (FIG. 7C) of packet 700 and sealingly enclose the sharpening composition “SC” within packet 700. The predetermined amount of sharpening composition “SC” to be added, which will be detailed below, depends upon size and/or type of blades to be sharpened as well as the hardness and average initial crystal size of the sharpening composition “SC,” as noted above.

In embodiments, the configuration resulting from assembly of packet 700 detailed above, as can be appreciated, is such that base portion 706 forms the concave bottom of packet 700, while the side edges and top of the packet 700 are sealed to enclose and retain the sharpening composition “SC” therein. With regard to the dimensions of packet 700, the end edges that extend along first and second top portions 708a, 708b, respectively, define a width “X₁” of packet 700 of about 4.5 inches. The side edges that extend along the edges of first top portion 708a, first body portion 702, base portion 706, second body portion 704, and second top portion 708b define half-lengths “X₂” of about 3 inches, thus defining overall, unassembled lengths of about 6 inches. The assembled, functional length “X₃” of packet 700 is greater than about 2.5 inches but less than 3 inches. The functional length “X₃” is less than the half-length “X₂” due to the fact that top portions 708a, 708b are removed prior to use such that the interior of packet 700 is accessible, as detailed below, and also due to the fact that base portion 706 is curved or U-shaped, rather than being folded in half. These dimensions are sufficiently large so as to permit insertion of a wide range of cutting devices therein and sufficiently small so as to allow substantially all of the sharpening composition “SC” to circulate between the blades to facilitate sharpening thereof. Likewise, the U-shape facilitates circulation of the sharpening composition “SC” and inhibits bunching of crystals, as has been found to be the case where a fold along the base is provided.

Referring to FIG. 7B in particular, packet 700 forms a suitable moisture, oxygen, and microbial barrier to protect the sharpening composition “SC” and give packet 700 a suitable shelf-life of at least one year. The packet 700 is formed from multiple layers such that packet 700 is configured to be strong, frictionless, flexible, puncture-resistant, and dimensioned such that the blades to be sharpened can be inserted and activated to sharpen the blades, similarly as detailed above, without damaging packet 700 or catching thereon. In order to achieve these properties, in embodiments, packet 700 includes at least one support layer, at least one barrier layer and at least one foil layer. More specifically, in embodiments, packet 700 includes at least one inner-most polymer layer 720. at least one stiffening thermoplastic layer 730 disposed outwardly of the polymer layer 720, at least one foil layer 740 may be disposed outwardly of the stiffening thermoplastic layer 730, a heat conductive adhesive layer 750 disposed outwardly of the foil layer 740, and at least one outer-most stiffening thermoplastic layer 760.

In embodiments, inner most polymer layer 720 may comprise a polyester selected from the group consisting of poly(ethylene terephthalate), poly(cyclohexylenedimethylene terephthalate), poly(ethylene dodecate), poly(butylene terephthalate), poly(ethylenenaphthalate), poly(ethylene 2,7-naphthalate), poly(methaphenylene isophthalate), poly(glycolic acid), poly(ethylene succinate), poly(ethylene adipate), poly(ethylene sebacate), poly(decamethylene azelate), poly(decamethylene sebacate), poly(dimethylpropiolactone), poly(ethylene isophthalate), poly(tetramethylene terephthalate), poly(hexamethylene terephthalate), poly(decamethylene terephthalate), poly(1,4-cyclohexane dimethylene terephthalate)(trans), poly(ethylene 1,5-naphthalate), poly(ethylene 2,6-naphthalate), poly(1,4-cyclohexylene dimethylene terephthalate), and combinations thereof. In embodiments, a suitable polyester for the inner most polymer layer may be polyethylene terephthalate with a thickness of from about 0.00010 to about 0.0050 inches.

In embodiments, at least one stiffening thermoplastic layer 730 may be formed by a material selected from the group consisting of: low density polyethylene (LDPE), linear low density polyethylene (LLDPE), high density polyethylene (HDPE), blends thereof, polypropylene homopolymer, polypropylene random copolymer, styrene/butadiene copolymer, polystyrene, ethylene-vinyl acetate copolymer and cyclic-olefin copolymer, and combinations thereof. In embodiments, a suitable stiffening thermoplastic layer of the present disclosure may be LDPE with a thickness of from about 0.00010 to about 0.0050 inches.

In embodiments, heat conductive adhesive layer 750 may be an anisotropic conductive paste (ACP) layer having any suitable thickness. The ACP is in paste format that can be printed and/or dispensed on an aligning substrate surface such as the foil layer. The ACP is typically a material including a conductive filler and binder. As an example, the conductive filler is gold plated resin balls, and the binder is synthetic rubber in a thinner. The binder is capable of bonding two or more articles together using the ACP as an interconnect material after the curing of paste.

In embodiments, the multiple layers of packet 700 may be formed by other suitable materials, layers, and/or configurations thereof that achieve the above-noted properties.

As noted above, the effectiveness and timeliness of sharpening for a particular type and/or size of blades is based at least upon the average initial crystal size, hardness of the crystals, and amount of crystals, e.g., the amount of sharpening composition “SC.” With respect to the amount of sharpening composition “SC,” it has been found that, in embodiments: (1) for sharpening trimmer blades (human and animal trimmers of all sizes), an amount in the range of about 0.05 ounces to about 0.25 ounces facilitates sharpening, in embodiments of from about 0.08 ounces to about 0.20 ounces facilitates sharpening; (2) for sharpening standard small clipper blades (e.g., human clipper blades sizes 0000, 000, and 0 A and animal clipper blades sizes 50, 40, 30, 15, and 10), and like sized and/or configured human and animal clippers, an amount in the range of from about 0.10 ounces to about 0.50 ounces facilitates sharpening, in embodiments of from about 0.18 ounces to about 0.30 ounces facilitates sharpening; (3) for sharpening medium clipper blades (e.g., human clipper blades sizes 1A, 1, and 1½ and animal clipper blades sizes 9, 8½, 7, and 6), and like sized and/or configured human and animal clippers, an amount in the range of from about 0.30 ounces to about 1.00 ounce facilitates sharpening, in embodiments of from about 0.45 ounces to about 0.65 ounces facilitates sharpening; and (4) for sharpening large clipper blades (e.g., human clipper blazed sizes 2, 3½, and 3¾ and animal clipper blades sizes 5, 4½, 4, 3¾, ⅝, and ¾) and like sized and/or configured human and animal clippers, an amount in the range of from about 0.40 ounces to about 1.50 ounces facilitates sharpening, in embodiments of from about 0.65 ounces to about 0.9 ounces facilitates sharpening.

Given the different ranges of sharpening composition “SC” amounts for the different sizes and/or types of blades to be sharpened, a plurality of packets 700 may be provided, each including a different amount of sharpening composition “SC” and being labeled, e.g., color-coded, accordingly. In embodiments, for example, a first or “trimmer” packet 700 may be provided with an amount of sharpening composition “SC” within the above-noted ranges for sharpening trimmer blades; a second, or “small” packet 700 may be provided with an amount of sharpening composition “SC” within the above-noted ranges for sharpening small clipper blades; a third or “medium” packet 700 may be provided with an amount of sharpening composition “SC” within the above-noted ranges for sharpening medium clipper blades; and a fourth or “large” packet 700 may be provided with an amount of sharpening composition “SC” within the above-noted ranges for sharpening large clipper blades.

Turning to FIG. 7C, in use, the appropriate packet 700, e.g., “trimmer,” “small,” “medium,” or “large,” is selected based upon the size and/or type of blades to be sharpened, and is cut along cut-line 707 (cut-lines 707a, 707b are printed on either side of packet 700 to facilitate identifying the cut location) to provide access to the interior of packet 700. Specifically, cut-line 707 is positioned just below the sealed top portion 708 adjacent the upper ends of first and second body portions 702, 704 such that, upon cutting along cut-line 707, the device to be sharpened can be inserted between first and second body portions 702, 704 until the blades thereof are disposed within the sharpening composition “SC.” Sharpening may then be effected similarly as detailed above (e.g., with completion being detected by viewing a color-change) and, after sharpening, the packet 700 and pulverized sharpening composition “SC” may be discarded.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A kit for use in sharpening blades of a hair cutting device, the kit comprising:
a packet defining an interior area that is sealingly enclosed within the packet; and
a pre-determined amount of a sharpening composition disposed within the interior area of the packet, the sharpening composition including a plurality of crystalline particles having exterior surfaces dyed a color different from the natural color of the crystals,
wherein the amount of sharpening composition, average initial diameter of the crystalline particles, and hardness of the crystalline particles are such that the sharpening composition facilitates sharpening of a hair cutting device.

2. The kit according to claim 1, wherein the packet includes a single piece of material, the single piece of material bent back on itself to define a lower end of the packet, the single piece of material sealed along first and second sides of the packet and an upper end of the packet to sealingly enclose the interior area of the packet.

3. The kit according to claim 2, wherein the packet includes a cut-line disposed adjacent the upper end of the packet, the cut-line indicating where to cut-open the packet to provide access to the interior area.

4. The kit according to claim 2, wherein the lower end of the packet defines a concave configuration such that the packet defines a U-shaped configuration.

5. The kit according to claim 2, wherein the single piece of material is sealed along the first and second sides and the upper end via heat sealing.

6. The kit according to claim 1, wherein the packet is formed from a plurality of layers including at least one support layer and at least one barrier layer.

7. The kit according to claim 6, wherein the at least one support layer includes a foil layer.

8. The kit according to claim 6, wherein the at least one barrier layer provides at least one of a moisture barrier, a microbial barrier, or an oxygen barrier.

9. The kit according to claim 1, wherein the pre-determined amount of sharpening composition is from about 0.05 ounces to about 1.5 ounces.

10. The kit according to claim 1, wherein the kit is configured for use in sharpening trimmer blades of a hair cutting device and wherein the pre-determined amount of sharpening composition is from about 0.05 ounces to about 0.25 ounces.

11. The kit according to claim 1, wherein the kit is configured for use in sharpening small blades of a hair cutting device and wherein the pre-determined amount of sharpening composition is from about 0.10 ounces to about 0.50 ounces.

12. The kit according to claim 1, wherein the kit is configured for use in sharpening medium blades of a hair cutting device and wherein the pre-determined amount of sharpening composition is from about 0.30 ounces to about 1.00 ounces.

13. The kit according to claim 1, wherein the kit is configured for use in sharpening large blades of a hair cutting device and wherein the pre-determined amount of sharpening composition is from about 0.40 ounces to about 1.50 ounces.

14. The kit according to claim 1, wherein the hardness of the plurality of crystalline particles is from about 2.6 and 4.5 according to the Mohs hardness scale.

15. The kit according to claim 14, wherein the sharpening composition includes a main crystalline substance having a hardness below about 2.6 according to the Mohs hardness scale, and wherein the sharpening composition further includes a hardening agent that increases the hardness of the main crystalline substance such that the hardness of the plurality of crystalline particles is from about 2.6 to 4.5 according to the Mohs hardness scale.

16. The kit according to claim 15, wherein the main crystalline substance is sodium chloride.

17. The kit according to claim 15, wherein the hardening agent is potassium iodide.

18. The kit according to claim 15, wherein the main crystalline substance is present in amounts of from about 70% to about 99% by weight of the sharpening composition.

19. The kit according to claim 15, wherein the hardening agent is present in amounts of from about 0.05% to about 10% by weight of the sharpening composition.

20. The kit according to claim 14, wherein the sharpening composition further includes at least one anti-coalescing agent in amounts of from about 0.05% to about 10% by weight of the sharpening composition.

21. The kit according to claim 1, wherein the exterior surfaces of the crystalline particles are dyed with at least one dying agent, the at least one dying agent is present in amounts of from about 0.05% to about 10% by weight of the sharpening composition.

22. The kit according to claim 1, wherein the sharpening composition further includes at least one preservative in amounts of from about 0.05% to about 10% by weight of the sharpening composition.

23. The kit according to claim 1, wherein the average initial diameter of the crystalline particles is from about 0.15 mm to about 0.90 mm.

24. A composition for use in sharpening blades of a hair cutting device, the composition comprising:
a plurality of crystalline particles including:
a main crystalline substance in amounts of from about 70% to about 99% by weight of the composition;
at least one hardening agent in amounts of from about 0.05% to about 10% by weight of the composition;
at least one anti-coalescing agent in amounts of from about 0.05% to about 10% by weight of the composition
at least one dying agent for dying an exterior surface of the plurality of crystalline particles a color different from a natural color of the crystals, the at least one dying agent is present in amounts of from about 0.05% to about 10% by weight of the composition;
wherein the hardness of the plurality of crystalline particles is from about 2.6 and 4.5 according to the Mohs hardness scale, and
wherein a predetermined amount of the crystalline particles, an average initial diameter of the crystalline particles, and a hardness of the crystalline particles are such that the composition facilitates sharpening of the hair cutting device.
